(19) United States
(12) Patent Application Publication
(10) Pub. No.: US 2017/0053314 A1
(43) Pub. Date: Feb. 23, 2017

(54) Displaying Advertisements In Application Launcher

(71) Applicant: Quixey, Inc., Mountain View, CA (US)

(72) Inventors: Eric J. Glover, Palo Alto, CA (US); Brent Harrison, Mountain View, CA (US)

(73) Assignee: Quixey, Inc., Mountain View, CA (US)

(21) Appl. No.: 14/831,512

(22) Filed: Aug. 20, 2015

(51) Int. Cl. G06Q 30/02; G06F 3/0484; G06F 3/0488; G06F 3/0481

(52) U.S. Cl. CPC G06Q 30/0267; G06F 3/04817; G06F 3/04842; G06F 3/0488; G06Q 30/0256

(57) ABSTRACT

A mobile computing device configured to display advertisements in an application launcher, which displays icons that may be selected by a user to launch a native application. The mobile computing device transmits an advertisement request to an advertisement server and receives an advertisement object in response to transmitting the advertisement request. The advertisement object includes information related to an advertisement. The advertisement indicates the application identifier of the native application and a state identifier that identifies an advertised state within the native application. The mobile computing device displays the advertisement in the application launcher by modifying the icons. The mobile computing device replaces or modifies an icon image and/or an icon caption based on the advertisement.

### TECHNICAL FIELD

This disclosure relates to displaying advertisements in an application launcher.

### BACKGROUND

Mobile computing devices can install and execute software applications. Software applications that are installed on a mobile computing device are often referred to as native applications. While some native applications can be purchased from a digital application store, many native applications are free-of-charge. Software developers of free native applications often use advertisements to generate revenues. A common practice of displaying advertisements is to display banner advertisements within the native application.

### SUMMARY

One aspect of the disclosure provides a mobile computing device that includes a touchscreen display, a memory that stores a native application, a transceiver, sensors and a computing processor. The computing processor executes computer-readable instructions that, when executed by the computing processor, cause the computing processor to display an icon corresponding with the native application on the touchscreen display via an application launcher. The application launcher launches the native application to a first state (e.g., default state) of the native application. The icon includes a first image (e.g., default icon image) associated with the native application. The mobile computing device may capture contextual data indicating a context of the computing device. The contextual data may include sensor measurements from the sensors, a search history indicating searches made by the mobile computing device and/or an application identifier (ID) identifying the native application.

The mobile computing device generates a first data container that represents an advertisement request. The advertisement request may include the contextual data. The mobile computing device transmits the advertisement request via the transceiver. In response to transmitting the advertisement request, the mobile computing device receives a second data container representing an advertisement object. The advertisement object includes information related to an advertisement. The advertisement may indicate the application ID of the native application and a state ID that identifies a second state (e.g., advertised state) of the native application. The second state is associated with the advertisement. The mobile computing device determines a second image (e.g., ad image). The second image represents the second state that is being advertised. The mobile computing device modifies the icon by replacing the first image (e.g., default image) with the second image (e.g., ad image) and displays the modified icon on the touchscreen display via the application launcher.

Another aspect of the disclosure provides a server (e.g., ad server). The server includes a network communication device, a storage device and a processing device. The storage device that stores information related to advertisements. The processing device executes computer-readable instructions that, when executed by the processing device, cause the processing device to receive a first data container representing an advertisement request. The advertisement request may include contextual data that indicates a context of a client computing device. The contextual data may include an application identifier (ID) that identifies a native application installed at the client computing device. The server determines advertisements corresponding with states of the native application installed on the client computing device. For each advertisement that corresponds with a state of the native application, the server determines a relevance score to indicate the relevance of the advertisement based on the context of the client computing device.

The server selects a threshold number of the advertisements based on the relevance score of the advertisements. For each advertisement that is selected, the server determines an icon-sized image that represents the state corresponding with the advertisement. The server may also determine an icon-sized string that represents the state corresponding with the advertisement. Furthermore, the server may determine a state access mechanism that can be used by an application launcher on the client computing device to launch the native application into the state corresponding with the advertisement (e.g., advertised state). The server generates a second data container representing an advertisement object. The advertisement object includes the icon-sized images, the icon-sized strings and the state access mechanisms of the selected advertisements. The server transmits the second data container to the client computing device via the network communication device.

Another aspect of the disclosure provides a mobile computing device that includes a touchscreen display, a memory storing a native application, a transceiver, sensors and a computing processor. The computing processor executes computer-readable instructions that, when executed by the computing processor, cause the computing processor to display an icon corresponding with the native application on the touchscreen display via an application launcher. The application launcher launches the native application to a first state (e.g., default state) of the native application. The icon includes a first image (e.g., default image) associated with the native application. The mobile computing device may capture contextual data indicating a context of the computing device. The contextual data may include sensor measurements from the sensors, a search history indicating searches made by the mobile computing device and/or an application identifier (ID) identifying the native application.

The mobile computing device generates a first data container representing an advertisement request. The advertisement request may include the contextual data. The mobile computing device transmits the advertisement request via the transceiver. In response to transmitting the advertisement request, the mobile computing device receives a second data container representing an advertisement object. The advertisement object includes information related to an advertisement. The advertisement indicates the application ID of the native application and a state ID that identifies a second state (e.g., advertised state) of the native application. The second state is associated with the advertisement. The mobile computing device includes means for displaying the advertisement in the application launcher.

In some implementations, the means for displaying the advertisement include the computing processor executing computer-readable instructions that, when executed by the computing processor, cause the computing processor to determine a second image that represents the second state that is being advertised. The computing processor modifies the icon by replacing the first image with the second image and displays the modified icon on the touchscreen display via the application launcher. In some scenarios, the means for displaying the advertisement may include the computing processor continuously modifying the icon to cycle between the first image and the second image.

In some implementations, the means for displaying the advertisement include the computing processor executing computer-readable instructions that, when executed by the computing processor, cause the computing processor to determine a text string that represents the second state that is being advertised. The computing processor modifies the icon by superimposing the text string onto the first image and displays the modified icon on the touchscreen display via the application launcher.

In some implementations, the means for displaying the advertisement include the computing processor executing computer-readable instructions that, when executed by the computing processor, cause the computing processor to determine a text string that represents the second state that is being advertised. The computing processor modifies the icon by replacing an icon label displayed adjacent to the first image with the text string and displays the modified icon on the touchscreen display via the application launcher.

In some implementations, the mobile computing device includes means for launching the native application in the second state that is being advertised. The means for launching the native application in the second state may include the computing processor executing computer-readable instructions that, when executed by the computing processor, cause the computing processor to configure the application launcher to launch the native application in the second state upon receiving a user selection of the icon. The computing processor receives the user selection of the icon; and launches the native application in the second state of the native application.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a diagram illustrating a conventional home screen of a mobile computing device.

FIG. 2 is a diagram illustrating an example mobile computing device that displays advertisements via an application launcher.

FIG. 3 is a schematic diagram of an example system that may be used to display advertisements in the application launcher.

FIG. 4 is a block diagram of an example mobile computing device that displays advertisements via the application launcher.

FIG. 5 is a block diagram of an example method that the mobile computing device may use to display advertisements via the application launcher.

FIG. 6 is a block diagram of an example advertisement server that determines advertisements that can be displayed by the mobile computing device in the application launcher.

FIGS. 7A-E illustrate block diagrams of example methods that the advertisement server may use to determine advertisements that can be displayed in the application launcher.

FIGS. 8A and 8B are diagrams illustrating the mobile computing device displaying advertisements in the application launcher by changing the advertisements after a threshold amount of time.

FIGS. 9A and 9B are diagrams illustrating the mobile computing device displaying advertisements in the application launcher by scrolling advertisement images vertically or horizontally.

FIGS. 10A and 10B are diagrams illustrating the mobile computing device displaying advertisements in the application launcher by replacing an icon image with an advertisement image based on a search query.

FIGS. 11A and 11B are diagrams illustrating the mobile computing device displaying advertisements in the application launcher based on a state of a native application that is displaying on the mobile computing device prior to the home screen.

FIGS. 12A and 12B are diagrams illustrating the mobile computing device displaying advertisements in the application launcher by scrolling the advertisements horizontally or vertically.

Like reference symbols in the various drawings indicate like elements.

### DETAILED DESCRIPTION

Mobile computing devices can install and execute native applications. A native application may refer to a software product (e.g., a software program) that, upon execution, causes the mobile computing device to perform a function. While some native applications have a price, many native applications can be downloaded free-of-charge. Many free native applications display advertisements to generate revenues. Some users appreciate advertisements because the advertisements often relate to relevant products and the services. But to view and act upon the advertisements, the user has to first launch the native application. Hence, if a native application is not launched, neither the user nor the application developers benefit from the native application's ability to display banner advertisements.

The present disclosure provides an application launcher that, in addition to launching the native applications, displays advertisements. The application launcher may display the advertisements by modifying icon images and/or icon captions. Displaying advertisements in the application launcher benefits both the user and the application developers. User can view and act upon relevant advertisements directly from the home screen. Similarly, application developers have an opportunity to generate advertisement revenues even though their native application has not been launched.

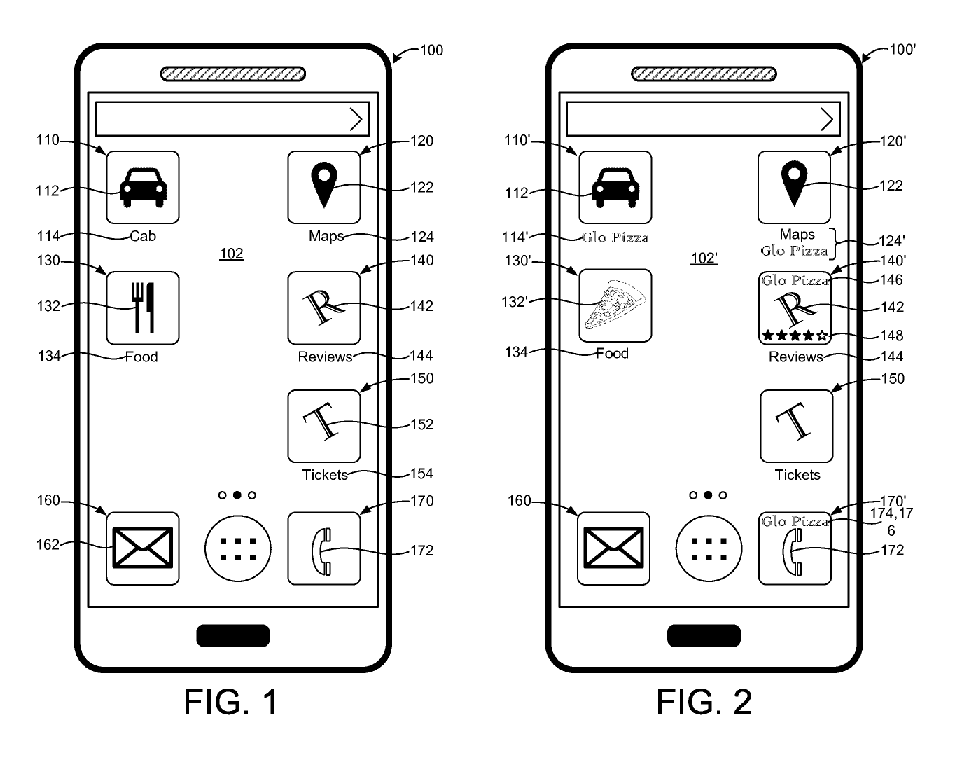

FIG. 1 illustrates a mobile computing device 100 that includes various native applications (not shown). The mobile computing device 100 may include an application launcher (not shown). An application launcher may include a set of computer-readable instructions that are executed by the mobile computing device 100 to launch the native applications. The application launcher may be included in an operating system of the mobile computing device 100. Alternatively, the application launcher may be provided by a third-party developer and can be installed by the user of the mobile computing device 100. In other words, the application launcher may itself be a native application. Launching a native application may refer to retrieving computer-readable instructions corresponding with the native application from a memory of the mobile computing device 100 and executing the computer-readable instructions at a computing processor.

The application launcher may display a home screen 102 that displays various icons 110, 120, 130, 140, 150, 160, 170 that correspond with the native applications. Each icon may include an icon image 112, 122, 132, 142, 152, 162, 172 and some icons may include an icon caption 114, 124, 134, 144, 154. The mobile computing device 100 may receive a user selection of a particular icon and launch the native application corresponding with the icon in response to the user selection. For example, the mobile computing device 100 may receive a user selection of the icon 130 and launch the native food application. Each native application may include several states that may relate to different entities. The mobile computing device 100 may launch the native application into a default state of the native application.

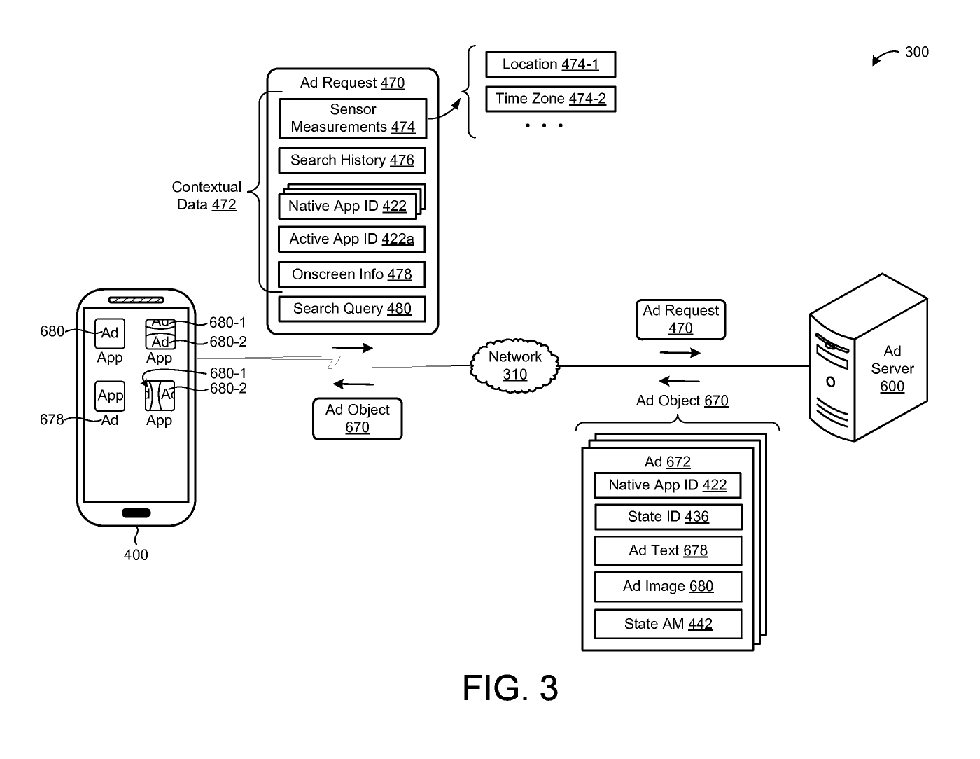

FIG. 2 illustrates a mobile computing device 100′ that displays advertisements via the application launcher. The application launcher can display a home screen 102′ that includes icons 110′, 120′, 130′, 140′, 150′, 160′, 170′. The application launcher may display the advertisements by modifying or replacing the icons. For example, the application launcher may display an advertisement for a pizza store (e.g., Glo Pizza) by replacing the original icon caption 114 shown in FIG. 1 with a replacement icon caption 114′. In the example of icon 110′, the replacement icon caption 114′ includes a name of the advertised entity. Alternatively, the application launcher may modify an original icon caption by appending the name of the advertised entity. Referring to the icon 120′, the application launcher modified the original icon caption 124 in FIG. 1 into the modified icon caption 124′ by appending the name of the advertised entity. In the example of the icon 120′, the name of the advertised entity is displayed below the name of the native application.

The mobile computing device 100′ may display advertisements by replacing or modifying the icon images. In the example of icon 130′, the application launcher replaces the original icon image 132 in FIG. 1 with a replacement icon image 132′. The replacement icon image 132′ corresponds with the advertised entity. Alternatively, the application launcher may modify the original icon image by superimposing a text string that refers to the advertised entity. In the example of icon 140′, the application launcher superimposes the text string 146 onto the icon image 142. Similarly, in the example of icon 170′, the application launcher superimposes the text string 174 onto the icon image 172. The text strings 146, 176 may include the name of the advertised entity.

The application launcher may modify an icon to display information from an advertised state of the native application. In the example of icon 140′, the application launcher displays an indicator 148 that indicates a rating of the advertised entity. The application launcher may determine the rating, for example, by making an application programming interface (API) call. For example, the application launcher may retrieve the rating from a particular state, within the native review application, that corresponds with Glo Pizza. Alternatively, the mobile computing device 100′ may receive the rating with the advertisement.

The application launcher may modify the icons 110′ . . . 170′ so that the native applications launch directly into the advertised states instead of the default states. For example, upon receiving a user selection of the icon 140′, the application launcher launches the native review application into a state that displays a review of Glo Pizza instead of the default state of the native review application. Similarly, upon receiving a user selection of the icon 170′, the application launcher launches the native phone application into a state that specifies Glo Pizza's phone number instead of the default state that requires a phone number to be entered.

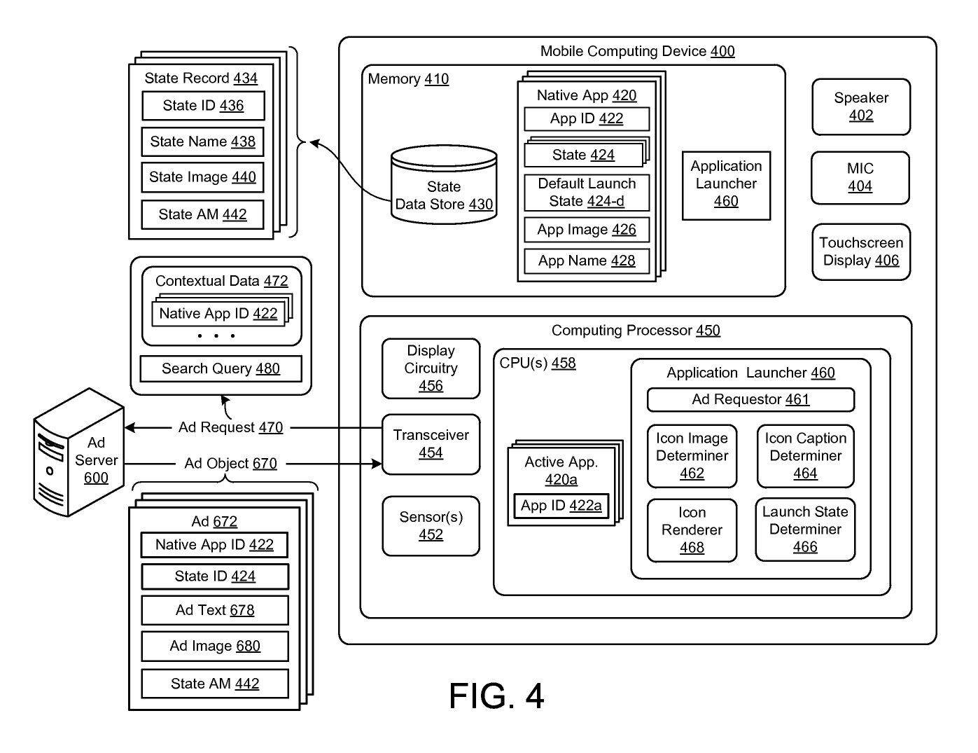

FIG. 3 illustrates a system 300 that delivers advertisements to an application launcher. The system 300 includes a client computing device 400 (e.g., the mobile computing device 100′ shown in FIG. 2) and an advertisement server 600. The system 300 may include a network 310 that enables electronic communication between the client computing device 400 and the advertisement server 600. The network 310 may include a wireless network (e.g., a cellular network) and/or a wired network (e.g., Ethernet).

In operation, the client computing device 400 transmits an advertisement (ad) request 470 to the ad server 600. The ad server 600 receives the ad request 470 and determines ads 672 based on the ad request 470. The ad server 600 transmits the ads 672 to the client computing device 400 in an ad object 670. The client computing device 400 receives the ad object 670 from the ad server 600 and displays the ads 672 in an application launcher.

The ad request 470 may include contextual data 472 that indicates a context of the client computing device 400. The contextual data 472 may include sensor measurements 474 captured by sensors of the client computing device 400. Example sensor measurements 474 include a location 474-1 of the client computing device 400 or a time zone 474-2 of the client computing device 400. The contextual data 472 may include a search history 476 that includes searches made through the client computing device 400 (e.g., a history of all searches or searches within a particular time period, for example, within the last 1-24 hours). The contextual data 472 may include native application identifiers (IDs) 422 that identify the native applications installed at the client computing device 400. The contextual data 472 may include active application IDs 422a that identify the native applications that are currently active (e.g., being used). The contextual data 472 may include onscreen information 478 (e.g., information that is currently being displayed or was being displayed within a time period, for example, the last 5 minutes). In addition to or as an alternative to the contextual data 472, the ad request 470 may include a search query 480 that includes one or more search terms.

The ad server 600 receives the ad request 470 from the client computing device 400 and determines ads 672 based on the ad request 470. The ad server 600 may use any suitable techniques for determining the ads 672. For example, the ad server 600 may employ an entity bidding approach that enables advertisers to place bids on entities in the search terms and/or entities indicated by the contextual data 472. Additionally or alternatively, the ad server 600 may employ a targeted advertising approach based on subscription tags. Example techniques for the ad server 600 to select the ads 672 are disclosed in U.S. patent application Ser. Nos. 14/259,873, 14/575,615, 14/575,485 and 14/810,160, the contents of which are incorporated by reference herein in their entireties. Furthermore, the ad server 600 may determine ads that are relevant near the location 474-1 of the client computing device 400. Moreover, the ad server 600 may determine ads that are relevant based on the current time in the time zone 474-2 of the client computing device 400.

The ad server 600 may select ads that correspond with states of the native applications installed at the client computing device 400. For example, the ad server 600 may limit the ads 672 to ads that correspond with states of native applications indicated by the native application IDs 422. Upon selecting ads that correspond with the native application IDs 422, the ad server 600 may rank ((e.g., score) the ads. Upon ranking the ads, the ad server 600 may include relatively higher ranking ads in the ad object 670 (e.g., top 1-5 ads) and exclude relatively lower ranking ads from the ad object 670 (e.g., ads not among top 5).

The ad object 670 may be a data container (e.g., a JavaScript Object Notation (JSON) file, XML file, etc.) that includes information related to the ads 672 determined by the ad server 600. For each ad 672, the ad object 670 may include the native application ID 422 corresponding with the ad 672. Additionally, the ad object 670 may include a state identifier (ID) 436 that identifies a particular state, within the native application identified by the native application ID 422, which is being advertised. The ad object 670 may include an ad text 678. The ad text 678 may be the name or heading of the state being advertised by the ad 672. The ad object 670 may include an ad image 680. The ad image 680 may be an image that represents the state being advertised by the ad 672. Lastly, the ad object 670 may include a state access mechanism 442 (e.g., a state access mechanism) that provides direct access to the advertised state. The state access mechanism 442 may include a string that references the advertised state (i.e., the state 424 identified by the state ID 436). The state access mechanism 442 may specify operations that can be performed by the client computing device 400. For example, the state access mechanism 442 may reference the advertised state by including an application resource identifier (ARI) or a uniform resource locator (URL) that identifies the advertised state and provides access thereto. Alternatively, the state access mechanism 442 may be a script that redirects the native application from the default state to the advertised state.

The client computing device 400 receives the ad object 670 from the ad server 600 and displays the ads 672 in the application launcher. The client computing device 400 may display an ad 672 by displaying the ad text 678 as the icon caption instead of or in addition to the original icon caption. Additionally or alternatively, the client computing device 400 may display an ad 672 by displaying the ad image 680 as the icon image instead of or in addition to the original icon image. If there are multiple ads 672 that refer to the same native application ID 422, the client computing device 400 may display ad images 680-1, 680-2 for both the ads 672 instead of the original icon image. The client computing device 400 may switch between the ad images 680-1, 680-2 every T seconds (e.g., every 5 seconds). Alternatively, the client computing device 400 may display the ad images 680-1, 680-2 so that the ad images 680-1, 680-2 are continuously scrolling (e.g., scrolling vertically or horizontally).

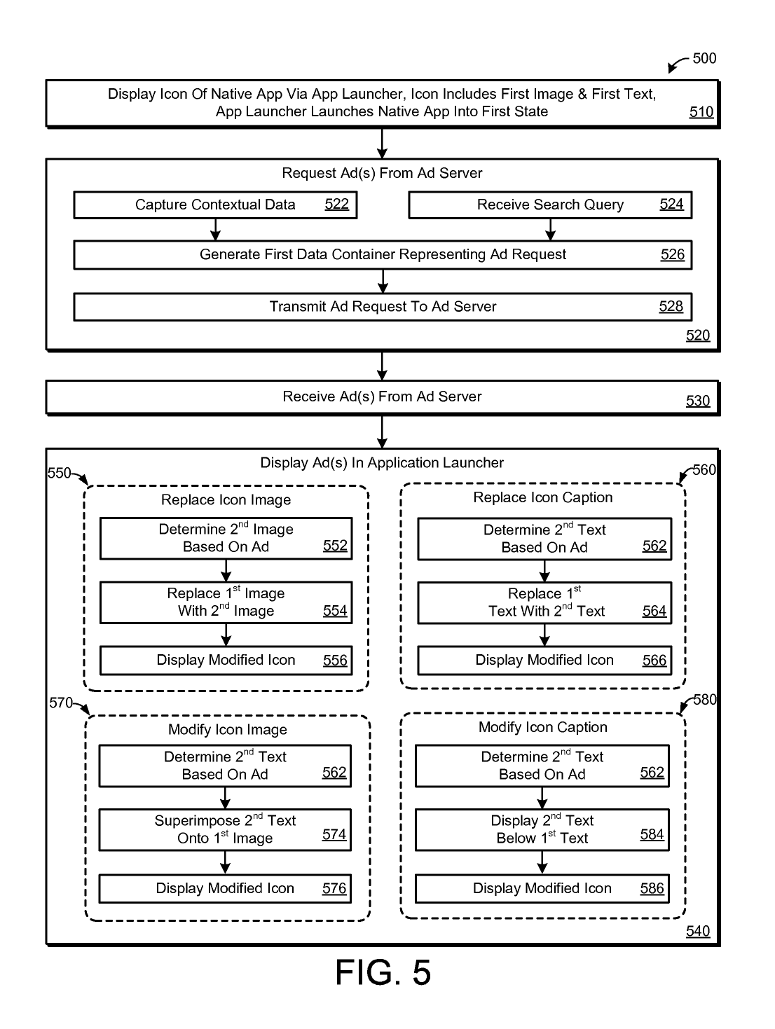

FIG. 4 is an example block diagram of the mobile computing 400. The mobile computing device 400 may include a speaker 402, a microphone 404, a touchscreen display 406, a memory 410 and a computing processor 450. The memory 410 stores native applications 420 that are installed on the mobile computing device 400. Each native application 420 may include a native application ID 422 (application ID 422, hereinafter) that identifies the native application 420. Each native application 420 may include various application states 424 (states 424, hereinafter). Each state 424 may correspond with a different entity and display information related to the entity. For example, a particular state, within a native review application, may correspond with a pizza store entity and may display crowd-sourced reviews of the pizza store. The native application 420 may identify one of the states 424 as a default launch state 424-d that is presented (e.g., displayed) when the native application 420 is launched. The native application 420 may include an application image 426 that can be used as the default icon image and an application name 428 that can be used as the default icon caption.

In some scenarios, the memory 410 may store a state data store 430 that stores information about the states 424 of the native applications 420. The state data store 430 includes state records 434 that correspond with the states 424 of the native applications 420. Each state record 434 may include a state ID 436 that identifies the corresponding state 424. The state record 434 may include a state name 438. The state name 438 may be the name of the entity associated with the state 424. The state name 438 may be a heading displayed by the state 424. The state record 434 may include a state image 440. The state image 440 may be a screenshot of the state 424 or a portion of the state 424. Alternatively, the state image 440 may be an image that represents the state 424 (e.g., a logo of the advertised entity).

The state record 434 may include a state access mechanism 442 that can be used to launch the native application 420 into the state 424. The state access mechanism 442 can be used to directly access the state 424 without navigating through a default state of the native application 420. The state access mechanism 442 may include a string that references the native application 420 and the state 424. Additionally, the state access mechanism 442 may indicate one or more operations that the mobile computing device 400 can perform. For example, the state access mechanism 442 may be an application resource identifier (ARI) or a uniform resource locator (URL) that identifies the state 424 and provides access thereto. Alternatively, the state access mechanism 442 may be a script that redirects the native application from the default state 424-d to the state 424. As an alternative to storing the state data store 430, the mobile computing device 400 may request the information regarding the states from a server (e.g., an application server) that stores the state data store 430.

The memory 410 may store an application launcher 460. The application launcher 460 launches the native applications 420. The application launcher 460 may be a native application 420. Alternatively, the application launcher 460 may be an operating system or a part thereof. The application launcher 460 displays icons for the native applications 420. The icons include icon images and icon captions. The application launcher 460 may use the application images 426 as default icon images and the application names 428 as default icon captions. Upon receiving a user selection of an icon, the application launcher 460 may launch the native application 420 into the default launch state 424-d.

The computing processor 450 may include one or more sensors 452, a transceiver 454, display circuitry 456 and one or more CPUs 458. Referring to the sensors 452, example sensors 452 include a location sensor that determines a location of the mobile computing device 400. The location sensor may use Global Positioning System (GPS) and/or Global Navigation Satellite System (GLONASS). The sensors 452 may include an accelerometer, a magnetometer, a gyroscope, a thermometer, a fingerprint reader, etc. The sensors 452 capture sensor measurements. The sensors 452 may capture the sensor measurements periodically and/or in response to a request. The computing processor 450 may store the sensor measurements captured by the sensors 452 in the memory 410. The computing processor 450 may retrieve the stored sensor measurements from the memory 410 and use the retrieved sensor measurements at a later time. For example, the computing processor 450 may include the sensor measurements in the ad request 470.

The display circuitry 456 causes the touchscreen display 406 to display information. The display circuitry 456 may receive user input (e.g., user selections) from the touchscreen display 406. The display circuitry 456 may include a display driver. The display driver may drive the touchscreen display 406. For example, the display circuitry 456 may include a Light Emitting Diode (LED) driver that may drive a LED display. The display circuitry 456 may drive a stereoscopic display (e.g., an autostereoscopic 3D display).

The transceiver 454 enables electronic communication with the ad server 600. The transceiver 454 may include a cellular transceiver, for example, a LTE transceiver, a LTE-Advanced transceiver, or a 5G (5^{th} generation mobile network) transceiver. The transceiver 454 may include a Wireless Fidelity (Wi-Fi) transceiver. The transceiver 454 may include a ZigBee transceiver, a Bluetooth transceiver (e.g., Bluetooth Low Energy transceiver), a Near Field Communications (NFC) transceiver, etc. The transceiver 454 may communicate with the ad server 600 via wired communications. For example, the transceiver 454 may communicate with the ad server 600 via an Ethernet cable, a USB cable, or the like.

The transceiver 454 may enable the mobile computing device 400 to communicate with electronic devices that are proximate to the mobile computing device 400. An electronic device may be referred to as being in proximity with the mobile computing device 400 when the mobile computing device 400 can communicated with the electronic device via short-range communications (e.g., Wi-Fi, NFC, Bluetooth, ZigBee, etc.). Alternatively or additionally, an electronic device may be referred to as being in proximity with the mobile computing device 400 when a distance between the mobile computing device 400 and the electronic device is less than a threshold distance (e.g., about 100 feet). Example electronic devices include appliances (e.g., refrigerator, stove, oven, microwave, coffee maker, toaster, etc.), home automation devices (e.g., thermostat, smoke detector, security system, etc.) and automobiles (e.g., cars, trucks, motorcycles, etc.). In some scenarios, the mobile computing device 400 may receive the ad object 670 via one of the electronic devices that are in proximity with the mobile computing device 400.

The CPU(s) 458 are capable of executing computer-readable instructions that cause the CPU(s) 458 to execute the native applications 420 and the application launcher 460. The CPU(s) 458 may be based on the reduced instruction set computing (RISC) architecture (e.g., an ARM processor). Alternatively, the CPU(s) 458 may be based on the complex instruction set computing (CISC) architecture (e.g., an x86 processor). The CPU(s) 458 may be based on other architectural models (e.g., quantum computing). The CPU(s) 458 may refer to a single CPU or to multiple CPUs (e.g., dual-core, quad-core or octa-core). The CPU(s) 458 may include general-purpose CPU(s) or special-purpose CPU(s), for example, Application Specific Integrated Circuit(s) (ASIC(s)). The CPU(s) 458 may execute the native applications 420 and the application launcher 460. Native applications that are being executed by the CPU(s) 458 may be referred to as active native applications 420a and their application IDs may be referred to as active application IDs 422a.

The application launcher 460 launches the native applications 420. The application launcher 460 launches a native application 420 in response to the mobile computing device 400 receiving a user selection to launch the native application 420 (e.g., upon receiving a user selection of an icon corresponding with the native application 420). To launch a native application 420, the application launcher 460 may instruct a kernel of the operating system to start a process for the native application 420. To start the process, the kernel may allocate memory for bookkeeping and then load (e.g., retrieve) the computer-readable instructions corresponding with the native application 420.

The application launcher 460 may include an ad requestor 461 that requests the ads 672. The ad requestor 461 may request the ads 672 by generating the ad request 470 and transmitting the ad request 470 to the ad server 600 via the transceiver 454. The ad requestor 461 may capture the contextual data 472 (e.g., by retrieving the contextual data 472 from the memory 410). Examples of the contextual data 472 include sensor measurements taken by the sensors 452, the native applications IDs 422, the active application IDs 422a, a search history and information displayed by the touchscreen display 406 (e.g., onscreen information). Alternatively or additionally, the ad requestor 461 may receive the search query 480 via a search box that enables a user of the mobile computing device 400 to enter the search query 480. The ad requestor 461 can generate the ad request 470 by creating (e.g., instantiating) a data container (e.g., a JSON file, XML file, etc.) that includes the contextual data 472 and/or the search query 480.

The application launcher 460 receives the ad object 670. The application launcher 460 may receive the ad object 670 in response to transmitting the ad request 470. Alternatively, the application launcher 460 may receive the ad object 670 without sending the ad request 470 (e.g., the ad is pushed to the application launcher 460). The application launcher 460 displays the ads 672 included in the ad object 670. The application launcher 460 can display the ads 672 by modifying or replacing the icon captions and/or the icon images of icons that are used to launch the native applications 422.

The application launcher 460 may include an icon image determiner 462 that determines an icon image that is displayed within an icon. The icon image determiner 462 may determine the icon image of an icon by retrieving the application image 426 indicated by the native application 420. The icon image determiner 462 may format the application image 426. For example, the icon image determiner 462 may re-size the application image 426 to a size that is suitable for use as an icon image.

The icon image determiner 462 may replace or modify the icon image to display the ads 672. If an ad 672 specifies the ad image 680, the icon image determiner 462 can use the ad image 680 as the icon image. To use the ad image 680 as the icon image, the icon image determiner 462 may replace the application image 426 with the ad image 680. Alternatively, the icon image determiner 462 may display the ad image 680 and the application image 426 by alternating between the ad image 680 and the application image 426 every T seconds (e.g., every 5 seconds). Alternatively, the icon image determiner 462 can display the ad image 680 and the application image 426 concurrently. For example, the icon image determiner 462 may superimpose the ad image 680 onto a portion of the application image 426. In some scenarios, the ads 672 may not include the ad image 680. If the ads 672 include the state ID 436, the icon image determiner 462 may use the state image 440 associated with the state ID 424 as the icon image.

The icon image determiner 462 may modify the icon image by superimposing the ad text 678 onto the icon image. The icon image determiner 462 may superimpose the ad text 678 onto the icon image as an alternative to replacing the current icon image. For example, the icon image determiner 462 may continue to use the application image 426 as the icon image and superimpose the ad text 678 onto the application image 426. The icon image determiner 462 may superimpose the ad text 678 onto the icon image in addition to replacing the current icon image.

The application launcher 460 may include an icon caption determiner 464 that determines an icon caption that is displayed within an icon. The icon caption may be displayed adjacent to the icon image (e.g., below the icon image). The icon caption determiner 464 may determine the icon caption of an icon by retrieving the application name 428 of the native application 420. The icon caption determiner 464 may format the application name 428. For example, the icon caption determiner 464 may truncate the application name 428 to a size that is suitable for use as an icon caption (e.g., less than a threshold number of characters, for example, less than 10 characters).

The icon caption determiner 464 may replace or modify the icon caption to display the ads 672. If an ad 672 specifies the ad text 678, the icon caption determiner 464 can use the ad text 678 as the icon caption. To use the ad text 678 as the icon caption, the icon caption determiner 464 may replace the application name 428 with the ad text 678. Alternatively, the icon caption determiner 464 may display the ad text 678 and the application name 428 by alternating between the ad text 678 and the application name 428 every T seconds (e.g., every 5 seconds). In such implementations, the icon caption determiner 464 may utilize a counter that counts seconds to determine when a period of T seconds has lapsed. Alternatively, the icon caption determiner 464 can display the ad text 678 and the application name 428 concurrently. For example, the icon caption determiner 464 may display the ad text 678 adjacent to (e.g., below) the application name 428. In some scenarios, the ads 672 may not include the ad text 678. If the ads 672 include the state ID 436, the icon caption determiner 464 may use the state name 438 associated with the state ID 424 as the icon caption.

The application launcher 460 may include a launch state determiner 466 that determines a state 424 into which a native application 420 is launched. The launch state determiner 466 may use the default launch state 424-d as the state 424 into which the native application 420 is launched. The launch state determiner 466 may launch the native application 420 into the state 424 identified by the ad 672. If the ad 672 includes the state access mechanism 442 for the advertised state, the launch state determiner 466 may launch the native application 420 directly into the advertised state instead of the default launch state 424-d. If the ad 672 does not include the state access mechanism 442, the launch state determiner 466 may use the state ID 436 indicated by the ad 672 to retrieve the state access mechanism 442 from the state data store 430.

The application launcher 460 may include an icon renderer 468 that renders (e.g., displays) the icons. The icon renderer 468 renders the icons by displaying the icon image determined by the icon image determiner 462 and the icon caption determined by the icon caption determiner 464. The icon renderer 468 may detect a user selection of an icon and launch the corresponding native application in response to detecting the user selection. The icon renderer 468 launches the native application 420 into the state 424 determined by the launch state determiner 466. For example, the icon renderer 468 may launch the native application 420 into the default launch state 424-d. Alternatively, the icon renderer 468 may launch the native application into the advertised state identified by the state ID 436 included in the ad 672.

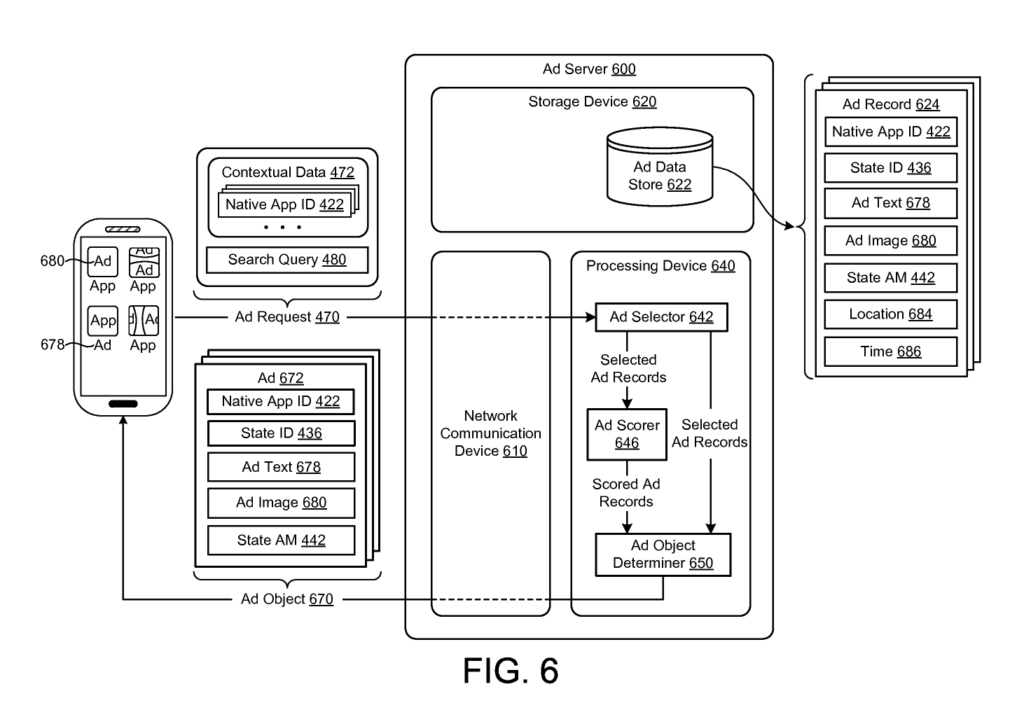

FIG. 5 is a block diagram of an example method 500 that may be executed by a mobile computing device (e.g., client computing device) to display ads in an application launcher. The method 500 may be implemented as a set of computer-readable instructions that are executed by the computing processor of the mobile computing device. In some scenarios, a portion of the method 500 may be executed by a processing device at a server (e.g., the ad server). At 510, the mobile computing device displays icons of native applications via an application launcher. The icons include icon images and/or icon captions. The icon images may be images associated with the native applications. For example, the icon images may include trademarks associated with the native applications. The icon captions may be text strings associated with the native applications. For example, the icon captions may include trade names associated with the native applications. The icon captions may include names of the native applications. The application launcher may launch the native application into a default state of the native application upon receiving a user selection of the icon. The native applications may indicate their default states.

At 520, the mobile computing device requests ads from an ad server. Requesting the ads may include capturing contextual data (at 522) or receiving a search query (at 524). Capturing the contextual data may include capturing sensor measurements taken by sensors of the mobile computing device. Example sensor measurements include a location of the mobile computing device, a time zone of the mobile computing device, an accelerometer reading, a magnetometer reading, a gyroscope reading, etc. Capturing the contextual data may include retrieving application IDs of native applications installed at the mobile computing device. Additionally or alternatively, capturing the contextual data may include retrieving an application identifier of the currently active application. In this way, the contextual data may identify application IDs of native applications that are currently active (e.g., currently being executed by a computing processor of the mobile computing device). In some implementations, the contextual data further indicates state information indicating a state or states of applications currently being accessed by the active application(s). In some of these implementations, the contextual data may include or be indicative of onscreen information (e.g., information currently being displayed on a touchscreen display of the mobile computing device).

Regarding 524, the mobile computing device may receive the search query via a search box in which a user of the mobile computing device can enter search terms. Alternatively, the mobile computing device may receive the search query via a microphone of the mobile computing device as audio input from the user. The application launcher may display the search box on a home screen of the mobile computing device along with icons of the native applications.

At 526, the mobile computing device instantiates a new ad request. The ad request may include unparameterized variables (e.g., unpopulated variables) that the mobile computing device can parameterize (e.g., populate) using the contextual data, the search query and/or any other suitable data. The mobile computing device can generate a data container that represents the ad request. The data container may be a JSON file, an XML file, or any other suitable data object that can be used to transport data. The ad request may include the contextual data captured at 522 and/or the search query received at 524.

At 528, the mobile computing device transmits the ad request to an ad server. The mobile computing device transmits the ad request via a transceiver of the mobile computing device. The mobile computing device may transmit the ad request periodically. Alternatively or additionally, the mobile computing device may transmit the ad request in response to detecting a trigger. For example, the mobile computing device may transmit the ad request in response to the mobile computing device displaying the home screen. The mobile computing device may transmit the ad request in response to the mobile computing device receiving the search query.

At 530, the mobile computing device receives ads from the ad server. The mobile computing device may receive the ads in response to transmitting the ad request to the ad server. Alternatively, the mobile computing device may receive the ads irrespective of the ad request. The mobile computing device may receive the ads in a data container representing an ad object (e.g., a JSON file, an XML file, etc.). The ad object may include information related to the ads. For example, an ad may identify a native application with which the ad is associated. The ad may also identify an advertised state by indicating a particular state within the native application. The ad may include a state access mechanism (e.g., an access URL, a script or a macro) that provides direct access to the advertised state. The ad may include an ad image that can be used to modify the icon image of the native application associated with the ad. Similarly, the ad may include an ad text that can be used to modify the icon caption of the native application associated with the ad.

At 540, the mobile computing device displays ads in the application launcher. The mobile computing device may use various techniques to display the ads in the application launcher. For example, at 550, the mobile computing device may display an ad by replacing a current icon image with the ad image. Additionally or alternatively, at 560, the mobile computing device may display the ad by replacing a current icon caption with the ad text. Instead of replacing the current icon image, the mobile computing device may modify the icon image based on the ad (at 570). Similarly, instead of replacing the current icon caption, the mobile computing device may modify the current icon caption based on the ad (at 580).

Referring to 550, the mobile computing device determines an ad image based on the ad (at 552). The mobile computing device may determine the ad image by retrieving the ad image from the ad object. Alternatively, if the ad object does not include the ad image, the mobile computing device may retrieve an image (e.g., a state image) corresponding with the advertised state of the native application from a data store. Alternatively, if the ad object does not identify the advertised state, the mobile computing device may identify an ad text in the ad object and convert the ad text into an image format (e.g., into a JPEG, GIF, bitmap, etc.).

At 554, the mobile computing device replaces a current icon image (e.g., a default icon image) with the ad image determined at 552. The mobile computing device may replace the current icon image of a particular icon (e.g., the icon of the native application associated with the ad). Alternatively, the mobile computing device may replace the current icon image of multiple icons (e.g., even icons of native applications that may not be associated with the ads).

At 556, the mobile computing device displays the modified icon. The modified icon may statically display the ad image determined at 552. Alternatively, the modified icon may display the ad image dynamically. For example, if there are multiple ad images, the modified icon may display the multiple ad images by alternating between the different ad images (e.g., by scrolling through the ad images or changing the ad images every T seconds, for example, every 5 seconds). Another example of dynamically displaying the ad image is to alternate between the default icon image and the ad image (e.g., by switching between the default icon image and the ad image every T seconds, for example, by scrolling through the default icon image and the ad image).

Referring to 560, the mobile computing device determines an ad text based on the ad (at 562). The mobile computing device may determine the ad text by retrieving the ad text from the ad object. Alternatively, if the ad object does not include the ad text, the mobile computing device may retrieve the name (e.g., state name) of the advertised state of the native application from a data store (e.g., a state data store that stores information about the states of the native applications).

At 564, the mobile computing device replaces a current icon caption (e.g., default icon caption) with the ad text determined at 562. The mobile computing device may replace the current icon caption of a particular icon (e.g., the icon of the native application associated with the ad). Alternatively, the mobile computing device may replace the current icon caption of multiple icons (e.g., even icons of native applications that may not be associated with the ad).

At 566, the mobile computing device displays the modified icon. The modified icon may statically display the ad text determined at 562. Alternatively, the modified icon may display the ad text dynamically. For example, if there are multiple ad text strings, the modified icon may display the multiple ad text strings by alternating between the different ad text strings (e.g., by scrolling through the ad text strings or changing the ad text strings every T seconds, for example, every 5 seconds). Another example of dynamically displaying the ad text is to alternate between the default icon caption and the ad text (e.g., by switching between the default icon caption and the ad text every T seconds, for example, by scrolling through the default icon caption and the ad text).

Referring to 570, the mobile computing device may display an ad by modifying the current icon image instead of replacing the current icon image with the ad image. For example, the mobile computing device may superimpose the ad text (determined at 562) onto the current icon image (at 574). The mobile computing device may determine a size and/or a position of the ad text, so that a major portion of the current icon image is still visible and recognizable. For example, the mobile computing device may adjust a size of the ad text, so that ad text covers less than a threshold percentage (e.g., less than 25%) of the current icon image. Moreover, the mobile computing device may position the ad text towards the bottom or top of the current icon image, so that the ad text does not obscure the center portion of the current icon image, which is usually the more distinctive portion of the icon image.

At 576, the mobile computing device displays the modified icon with the ad text superimposed onto the current icon image. The mobile computing device may display the ad text in a static manner. For example, the ad text may remain displayed in the same position. Alternatively, the mobile computing device may display the ad text dynamically. For example, the ad text may move around (e.g., bounce within current icon image). Alternatively, the mobile computing device may display the ad text such that the ad text scrolls right-to-left or left-to-right.

Referring to 570, in some implementations, the mobile computing device can modify the current icon image (e.g., default icon image) by reducing (e.g., shrinking) the current icon image and displaying the ad image in the area previously occupied by the icon image. In other words, the mobile computing device can display the ad image and the default icon image simultaneously. The mobile computing device can launch the native application into the advertised state upon receiving a user selection of the ad image. Furthermore, the mobile computing device can launch the native application into the default state upon receiving a user selection of the reduced version of the default icon image. Advantageously, mobile computing device can enable a user of the mobile computing device to launch the native application into the advertised state by pressing one portion of the icon or the default state by pressing another portion of the icon.

Referring to 580, the mobile computing device may display an ad by modifying an icon caption instead of replacing the icon caption. For example, the mobile computing device may display the ad text (determined at 562) below the current icon caption (at 584). If there are multiple ad text strings corresponding with different ads, the mobile computing device may display the ad text strings by alternating between the ad text strings. For example, the mobile computing device may display a different ad text string every T seconds (e.g., 5 seconds).

At 586, the mobile computing device displays the modified icon with the ad text being displayed below the current icon caption (e.g., default icon caption). The mobile computing device may display the ad text in a static manner. For example, the mobile computing device may display the ad text such that the ad text remains stationary. Alternatively, the mobile computing device may display the ad text in a dynamic manner (e.g., so that ad text moves). For example, the mobile computing device may display the ad text such that ad text scrolls right-to-left or left-to-right.

Displaying the ads (at 540) may also include modifying a launch state of a native application. The mobile computing device may change the state into which the native application launches from the default launch state to the advertised state. If an ad includes a state access mechanism (e.g., an access URL, a script or a macro) that points to the advertised state, the mobile computing device can modify the launch state by launching the native application using the state access mechanism specified by the ad. If an ad object does not specify a state access mechanism for the advertised state, the mobile computing device can retrieve the state access mechanism for the advertised state from a data store (e.g., the state data store).

Displaying the ads (at 540) may also include displaying, in the application launcher, information that is displayed by the advertised states of the native applications. The mobile computing device may retrieve certain information that the advertised state of a native application displays and display the information in the application launcher. The mobile computing device may display the information by overlaying the information onto the icon image. For example, if an advertised state of the native review application displays a rating for Glo Pizza, the mobile computing device may retrieve the rating and display the rating by overlaying the rating onto the icon image. The mobile computing device may receive the information displayed by the advertised state from the ad server (e.g., as part of the ad object). Alternatively, the mobile computing device may retrieve the information displayed by the advertised state by making an API call to: an application server that hosts the native application; a website associated with the native application; or an instance of the native application executing on the mobile computing device.

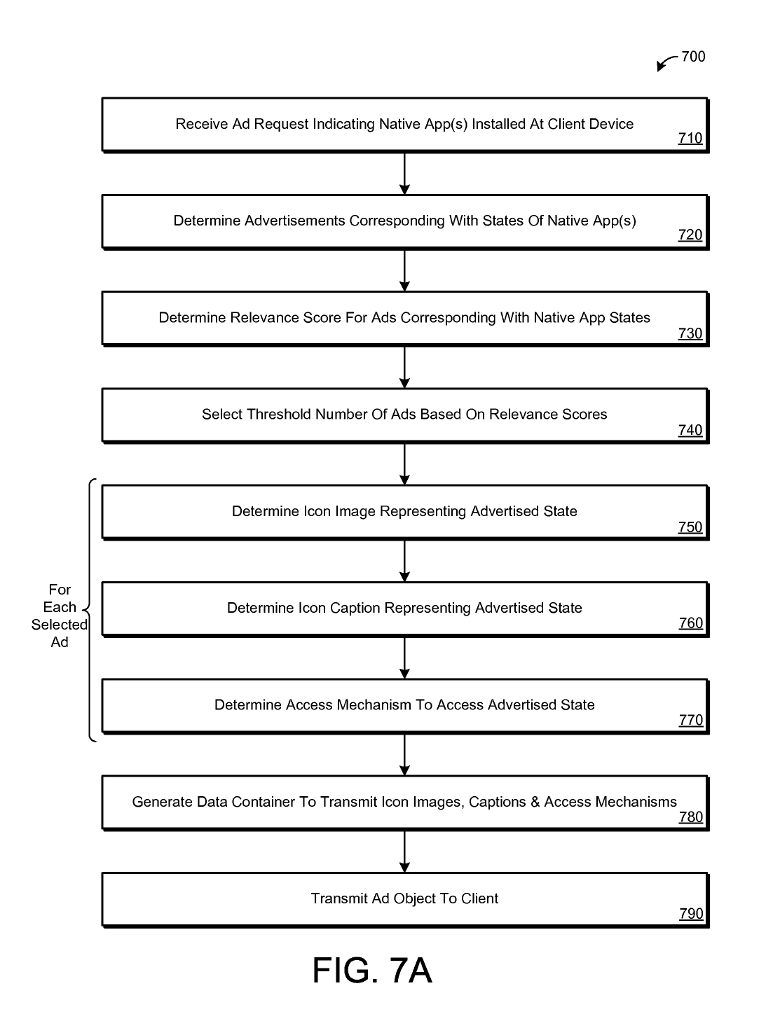

FIG. 6 is an example block diagram of the ad server 600. The ad server 600 receives the ad request 470 from the mobile computing device 400 and provides ads 672 in response to the ad request 470. The ad server 600 may include a network communication device 610, a storage device 620 and a processing device 640. The ad server 600 may be implemented by a cloud computing platform. The cloud computing platform may include a collection of remote computing services. The cloud computing platform may include computing resources (e.g., processing device 640). The computing resources may include servers (e.g., physical servers or virtual servers). The cloud computing resources may include storage resources (e.g., storage device 620). The storage resources may include database servers that support NoSQL, MySQL, Oracle, SQL Server, or the like. The cloud computing platform may include networking resources (e.g., network communication device 610). For example, the networking resources may distribute incoming requests for event notifications across multiple virtual private servers. Example cloud computing platforms include Amazon Web Services®, Google Cloud Platform®, Microsoft AZURE™ and Alibaba Aliyun™. The ad server 600 may be part of an application server that services a native application. The ad server 600 may be part of a third-party service provider that services multiple native applications. The ad server 600 may be part of a search engine that provides search results.

The network communication device 610 communicates with a network (e.g., the network 310 shown in FIG. 3). The network communication device 610 may include a communication interface that performs wired communication (e.g., via Ethernet, Universal Serial Bus (USB) or fiber-optic cables). The network communication device 610 may perform wireless communication (e.g., via Wi-Fi, Bluetooth, Bluetooth Low Energy (BLE), NFC, ZigBee, a cellular network, or satellites). The network communication device 610 may include a transceiver. The transceiver may operate in accordance with an Institute of Electrical and Electronics Engineers (IEEE) specification (e.g., IEEE 802.3 or IEEE 802.11). The transceiver may operate in accordance with a 3rd Generation Partnership Project (3GPP) specification (e.g., Code Division Multiple Access (CDMA), Long Term Evolution (LTE) or LTE-Advanced). The transceiver may operate in accordance with a Universal Serial Bus (USB) specification (e.g., via a USB port).

The storage device 620 stores data. The storage device 620 may include one or more computer readable storage mediums. For example, the storage device 620 may include solid state memory devices, hard disk memory devices, optical disk drives, read-only memory and/or nanotube-based storage devices. The storage device 620 may be connected to the processing device 640 via a bus and/or a network. Different storage mediums within the storage device 620 may be located at the same physical location (e.g., in the same data center, same rack, or same housing). Different storage mediums of the storage device 620 may be distributed (e.g., in different data centers, different racks, or different housings). The storage device 620 may implement (e.g., store) an ad data store 622.

The ad data store 622 stores ad records 624 that correspond with the ads 672. An ad record 624 may include a native application ID 422 that identifies a native application corresponding with the ad record 624. The ad record 624 may include a state ID 436 that identifies a state of the native application that is being advertised (e.g., the advertised state). The ad record 624 may include an ad text 678. The ad text 678 may include a string that contains alphanumeric characters. For example, the ad text 678 may be a trade name (e.g., a brand name). The ad record 624 may include an ad image 680. The ad image 680 may be a trademark (e.g., a branded image). The ad image 680 may be a JPEG, a GIF, a bitmap, or any other suitable image format. The ad image 680 may include a sequence of images that form an ad video.

The ad record 624 may include a state access mechanism 442 that provides direct access to the advertised state (e.g., the state identified by the state ID 436). The state access mechanism 442 may include a string that references the advertised state. The state access mechanism 442 may indicate operations that a mobile computing device can perform. The state access mechanism 442 may reference the advertised state by including an application resource identifier (ARI) or a uniform resource location (URL) that identifies the advertised state and provides access thereto. Alternatively, the state access mechanism 442 may include a script or a macro that automatically directs the native application from the default state to the advertised state after the native application is launched. The state access mechanism 442 may use other suitable techniques to provide access to the advertised state. The ad record 624 may include a location 684 that is associated with the ad record 624. The location 684 may indicate a geographic area where the ad 672 corresponding with the ad record 624 may be relevant. The ad record 624 may include a time 686 that indicates a specific time or a time duration during which the ad 672 corresponding with the ad record 624 may be relevant. The ad data store 622 may include one or more databases, indices (e.g., inverted indices), tables, Look-Up Tables (LUT), files, or other data structures.

The processing device 640 may include a collection of one or more computing processors that execute computer readable instructions. The computing processors of the processing device 640 may operate independently or in a distributed manner. The computing processors may be connected via a bus and/or a network. The computing processors may be located in the same physical device (e.g., same housing). The computing processors may be located in different physical devices (e.g., different housings, for example, in a distributed computing system). A computing processor may include physical central processing units (pCPUs). A pCPU may execute computer-readable instructions to implement virtual central processing units (vCPUs). The processing device 640 may execute computer-readable instructions corresponding with an ad selector 642, an ad scorer 646 and an ad object determiner 650.

The ad selector 642 selects the ad records 624 from the ad data store 622 based on the ad request 470. The ad selector 642 may select ad records 624 that correspond with the native applications installed at the mobile computing device 400. The ad selector 642 may utilize an inverted index that indexes the native application IDs 422 to the ad records 624. The ad selector 642 may use other information included in the ad request 470 to select the ad records 624. For example, the ad selector 642 may use a location of mobile computing device 400 that is included in the ad request 470 to select ad records 624 that may be relevant at that location. The ad selector 642 may utilize an inverted index that indexes the locations 684 to the ad records 624.

Similarly, the ad selector 642 may use a current time in the time zone of the mobile computing device 400 to select ad records 624 that may be relevant at the current time. The ad selector 642 may utilize an inverted index that indexes the times 686 to the ad records 624. For example, the ad selector 642 may query the inverted index with a data item (e.g., a location, a time, a keyword, etc.) and the inverted index can identify ad records 624 by providing ad record identifiers that identify the ad records 624. Alternatively, the ad selector 642 may use constraint-based searches, for example, by searching for ad records 624 that satisfy the time constraints indicated by the contextual data 472. The ad selector 642 may use a combination of the location and time to select the ad records 624. For example, if the ad request 470 indicates that the mobile computing device 400 is moving and is within 3 blocks of a Glo Pizza store between 11:45 am and 12:45 pm on Monday through Friday, the ad selector 642 can select the ad record 624 corresponding with Glo Pizza. The ad selector 642 may use any other suitable techniques for selecting the ad records 624 (e.g., entity bidding, targeted advertising based on subscription tags, etc.).

The ad scorer 646 may score the selected ad records to determine a relevance score for each of the selected ad records. The ad scorer 646 may use various scoring features in scoring the selected ad records. For example, the ad scorer 646 may use location as a scoring feature. Ad records that are associated with a location 684 that is closer to the mobile computing device 400 may receive a higher score than ad records with a location 684 that is farther from the mobile computing device 400. Similarly, the ad scorer 646 may use time as a scoring feature. Ad records 624 that are associated with a time 686 that is closer to the current time at the mobile computing device 400 may receive a higher score than the ad records 624 with a time 686 that is farther from the current time of the mobile computing device 400. The ad scorer 646 may use any other suitable scoring features to score the selected ad records. The ad scorer 646 may use a scoring function or scoring model that uses a combination of scoring features. For example, the scoring model may use a combination of location, time and any other suitable scoring features.

The ad object determiner 650 generates a data container that represents the ad object 670. The ad object determiner 650 retrieves information for the selected ad records from the ad data store 622 and includes the information in the ad object 670. The ad object determiner 650 may include information from all the selected ad records in the ad object 670. Alternatively, the ad object determiner 650 may include information for the highest scoring ad records in the ad object 670. For example, the ad object determiner 650 may include information for the ad records 624 that scored above a score threshold. For each ad 672, the ad object determiner 650 may include the native application ID 422, the state ID 436, the ad text 678, the ad image 680 and the state access mechanism 442. The ad object determiner 650 uses the network communication device 610 to transmit the ad object 670 to the mobile computing device 400.

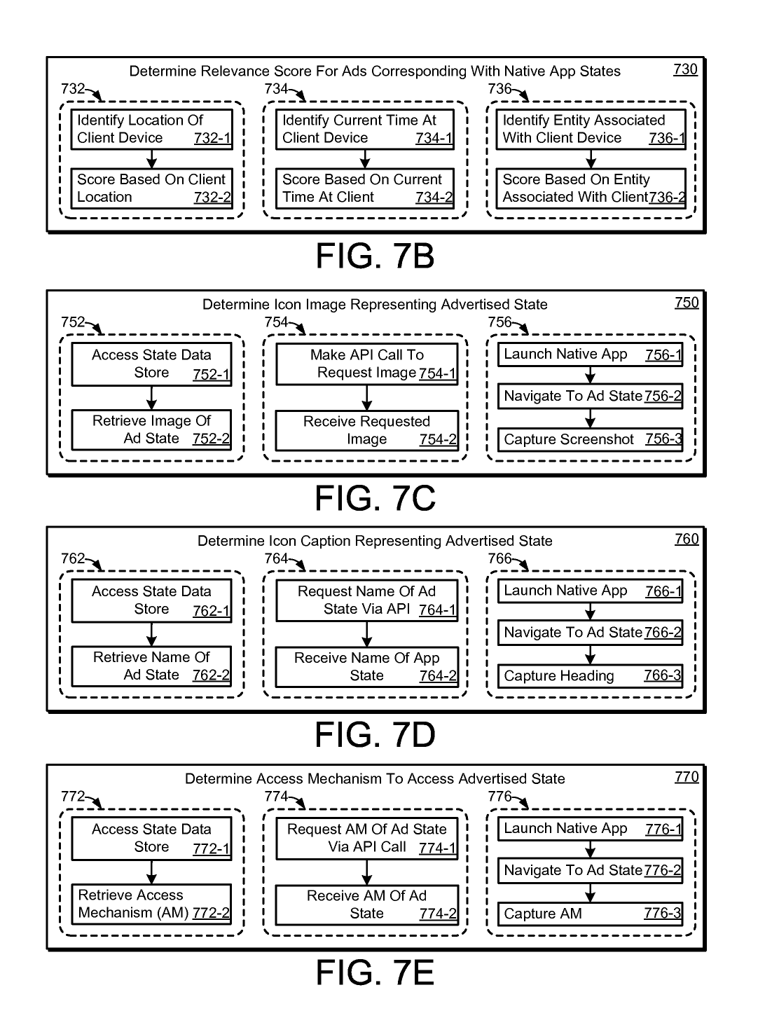

FIG. 7A is a block diagram of an example method 700 that may be used by a server (e.g., an ad server, an application server, etc.) to determine ads that can be displayed by a client computing device via an application launcher. The method 700 may be implemented as a set of computer-readable instructions that are executed by a processing device of the server.

At 710, the ad server receives an ad request. The ad server may receive the ad request directly from the client computing device or through a partner computing system (e.g., an internet search provider, a social network platform, a cellular service provider, etc.). The ad request may include a search query and/or contextual data that indicates a context of the client computing device. The contextual data may include application IDs that identify native applications installed at the client computing device. Additionally, the contextual data may include sensor measurements captured by sensors of the client computing device. Example sensor measurements may include a location of the client computing device, a time zone of the client computing device, an accelerometer reading, a magnetometer reading, a gyroscope reading, etc. The contextual data may also indicate which of the native applications installed at the client computing device are currently active or were previously active (e.g., currently being executed or were previously being executed). Furthermore, the contextual data may include onscreen information (e.g., information currently or previously being displayed at the client computing device).

At 720, the ad server determines ads that correspond with states of the native applications installed at the client computing device. The ad server may utilize an inverted index that indexes the application IDs to ad records in an ad data store. For example, the ad server may select the ad records based on the contextual data. In some scenarios, the ad server may select ad records that correspond with the location of the client computing device. In other scenarios, the ad server may select ad records that correspond with a current time in the time zone of the client computing device. For example, an ad record for Glo Pizza may be more relevant during lunch time (e.g., 12 pm-2 pm) or during dinner time (e.g., 6 pm-8 pm). The ad server can select the ad record for Glo Pizza, for example, if the current time in the time zone of the client computing device is 12:15 pm because the current time is within the time ranges associated with the ad record. The ad server may use other various techniques for selecting ad records from the ad data store (e.g., entity bidding, targeted advertising based on subscription tags, etc.).

At 730, the ad server scores the selected ad records to determine a relevance score for each of the selected ad records. The ad server may use various features to determine the relevance scores. In some examples, the ad server uses location as a feature in scoring the ad records. For example, the ad server may assign a higher score to ad records that correspond with locations closer to the client computing device and a lower score to ad records that correspond with locations farther from the client computing device. In other examples, the ad server may use time as a feature in scoring the ad records. For example, the ad server may assign a higher score to ad records that correspond with times closer to the current time at the client computing device and a lower score to ad records that correspond with times farther from the current time at the client computing device. The ad server may use any other suitable features for scoring the ad records. The ad server may use a machine-learned ranker that uses a model (e.g., a non-linear model) that considers multiple features (e.g., all features) to determine the relevance scores of the selected ad records. FIG. 7B illustrates example techniques that the ad server can use to determine the relevance scores.

At 740, the ad server selects a threshold number of ad records based on the relevance scores (e.g., top 1-5). The ad server may select the threshold number of ad records with the highest relevance scores. Alternatively, the ad server may select ad records that have a relevance score that is higher than a threshold score. The threshold number and/or the threshold score may be set by ad server and/or the client computing device.

For each ad record that is selected, the ad server determines an icon image (e.g., ad image) that represents the advertised state (at 750). The ad server may also determine an icon caption (e.g., ad text) that represents the advertised state (at 760) and a state access mechanism to access the advertised state (at 770). FIGS. 7C-E illustrate example techniques that the ad server can use to determine the icon image, the icon caption and the state access mechanism, respectively.

At 780, the ad server generates (e.g., instantiates) a data container that represents an ad object. The ad object includes various ads that the ad server selected at 740. The ad object may also include the icon images, the icon captions and the state access mechanisms that the ad server determined for each ad. The data container may be a JSON file, an XML file or any other suitable data exchange format.

At 790, the ad server transmits the ad object to the client computing device. The ad server may transmit the ad object directly to the client computing device. Alternatively, the ad server may transmit that ad object to the client computing device via the partner computing system. In some scenarios, the ad server can transmit the ad object to the client computing device even though the client computing device may not have sent an ad request recently. In such scenarios, the ad server can determine the ads in the ad object based on a previous ad request (e.g., an ad request sent a day ago or a week ago, etc.).

FIG. 7B is a block diagram that illustrates example techniques that the ad server may use to determine relevance scores. Referring to 732, the ad server may determine the relevance score of an ad record based on location. Ad records may be associated with locations. For example, an ad record for Glo Pizza may be associated with a 2 mile-square area around Glo Pizza.

At 732-1, the ad server identifies a location of the client computing device. The ad server may identify the location of the client computing device based on the sensor measurements included in the contextual data received from the client computing device. Alternatively, the ad server may request the location of the client computing device from a network node in the cellular infrastructure (e.g., the Home Location Register (HLR)).

At 732-2, the ad server determines the relevance score of the ad record based on the location of the client computing device and the location associated with the ad record. The ad server can compute a distance between the location of the client computing device and the location associated with the ad record. The distance represents a distance of the user from the advertised location. The ad server can assign a relevance score to the ad record based on the distance. For example, the ad server may include the distance in a feature vector that is used by a scoring model (e.g., a machine-learned scoring model) to calculate the relevance score for the ad record.

Referring to 734, the ad server can determine relevance scores of ad records based on time. Ad records may be associated with particular times or time periods. For example, an ad record corresponding with a restaurant may be more relevant around lunch time than an ad record corresponding with a night club.

At 734-1, the ad server identifies a current time at the client computing device. The ad request may indicate the current time at the client computing device. Alternatively, the ad request may indicate a time zone of the client computing device and the ad server may query an internet time server for the current time in the time zone of the client computing device.

At 734-2, the ad server determines relevance scores of ad records based on the current time at the client computing device and the time associated with the ad records. The ad server can assign a relatively higher score to an ad record if the time associated with the ad record and the current time at the client computing device are within a threshold time difference. Otherwise, if the time associated with the ad record and the current time at the client computing device are apart by more than the threshold time difference, the ad server can assign a relatively low score to the ad record.

Referring to 736, the ad server can determine relevance scores of ad records based on entity comparison. Ad records may be associated with different entities. At 736-1, the ad server can identify an entity associated with the ad request. For example, the ad server may identify an entity within the search terms of a search query. Alternatively, the ad server may identify an entity based on the onscreen information.

At 736-2, the ad server can assign higher scores to ad records that are associated with entities that match with the entities in the ad request. Similarly, the ad server can assign lower scores to ad records that are associated with entities that do not match with the entities in the ad request. The ad server may use a binary scoring feature to indicate whether the ad record includes an entity that matches an entity in the ad request. For example, the ad server may set the binary scoring feature to a value of ‘1’, if the ad record and the ad request share a common entity. Similarly, the ad server may set the binary scoring feature to a value of ‘0’, if the ad record and the ad request do not share a common entity. The ad server may include the binary scoring feature in a feature vector that is used by a scoring model to compute a relevance score for the ad record. The ad server may use any suitable technique to recognize entities in the ad request.

FIG. 7C is a block diagram that illustrates example techniques that the ad server can use to determine the icon image to represent an advertised state. Referring to 752, the ad server may access a data store (e.g., a state data store) that stores images associated with states of native applications (at 752-1). The ad server may utilize an inverted index that indexes state IDs to state images. At 752-2, the ad server retrieves the state image of the advertised state from the state data store. The ad server may resize the state image so that the state image can be displayed as an icon image. For example, the ad server may scale-down the state image, if the state image is much larger than a typical icon image.

Referring to 754, if the ad server does not store an image of the advertised state, the ad server can make an API call to request the image (at 754-1). The ad server can direct the API call to an application server that hosts the native application. Alternatively, the ad server can make the API call to a website associated with the native application or to an instance of the native application that is currently executing. At 754-2, the ad server receives the requested image in response to the API call. The ad server may use the received image as the icon image to represent the advertised state.

Referring to 756, if the icon image cannot be obtained from a data store or through an API call, the ad server may generate the icon image. At 756-1, the ad server may launch an instance of the native application. The ad server may launch the native application in an emulator that emulates the client computing device. Once the native application is launched, the native application may launch into the default state of the native application.

At 756-2, the ad server navigates to the advertised state of the native application. The ad server may navigate to the advertised state by selecting specific graphical user interface (GUI) elements in the native application. Alternatively, the ad server may launch the native application directly into the advertised state (e.g., by using a state access mechanism for the advertised state). At 756-3, the ad server generates the icon image representing the advertised state by capturing a screenshot. The ad server may capture a screenshot of a portion of the advertised state. Alternatively, the ad server may capture a screenshot of the entire advertised state.

FIG. 7D is a block diagram that illustrates example techniques that the ad server may use to determine an icon caption to represent the advertised state of a native application. Referring to 762, the ad server may access a data store (e.g., a state data store) that stores names for states of native applications (at 762-1). The ad server may utilize an inverted index that indexes state IDs to state names. At 762-2, the ad server retrieves the state name of the advertised state from the state data store. The ad server may modify the state name so that the state name can be displayed as an icon caption. For example, the ad server may truncate the state name, if the state name is longer than a threshold number of characters.

Referring to 764, if the ad server does not store a name for the advertised state, the ad server can make an API call to request the name (at 764-1). The ad server can direct the API call to an application server that hosts the native application. Alternatively, the ad server can make the API call to a website associated with the native application or to an instance of the native application that is currently executing. At 764-2, the ad server receives the requested name in response to the API call. The ad server may use the received name as the icon caption to represent the advertised state.

Referring to 766, if the icon caption cannot be obtained from a data store or through an API call, the ad server may generate the icon caption. The ad server may generate the icon caption by crawling and scraping the native application and/or a website associated with the native application. At 766-1, the ad server may launch an instance of the native application. At 766-2, the ad server navigates to the advertised state of the native application. The ad server may navigate to the advertised state by selecting specific graphical user interface (GUI) elements in the native application. Alternatively, the ad server may launch the native application directly into the advertised state (e.g., by using a state access mechanism for the advertised state). At 766-3, the ad server generates the icon caption representing the advertised state by capturing a heading of the advertised state. The ad server may capture the heading by identifying a metatag that uses a schema vocabulary (e.g., schema.org) to indicate that there is a heading encapsulated within the metatag.

FIG. 7E is a block diagram that illustrates example techniques that the ad server may use to determine a state access mechanism to access the advertised state of a native application. Referring to 772, the ad server may access a data store (e.g., a state data store) that stores access mechanisms for states of native applications (at 772-1). The ad server may utilize an inverted index that indexes state IDs to access mechanisms. At 772-2, the ad server retrieves the state access mechanism of the advertised state from the state data store. The state access mechanism may include an application resource identifier (ARI) or a URL that identifies the advertised state and provides access thereto. Alternatively, the state access mechanism may include a script that redirects the native application from the default state to the advertised state.

Referring to 774, if the ad server does not store a state access mechanism for the advertised state, the ad server can make an API call to request the state access mechanism (at 774-1). The API call may include a state ID that identifies the advertised state. Additionally, the API call may indicate an operating platform of the mobile computing device (e.g., an operating system version, etc.). The ad server can direct the API call to an application server that hosts the native application. Alternatively, the ad server can make the API call to a website associated with the native application or to an instance of the native application that is currently executing. At 774-2, the ad server receives the requested access mechanism in response to the API call. The ad server may use the received access mechanism to launch the native application directly into the advertised state instead of the default state.

Referring to 776, if the state access mechanism cannot be obtained from a data store or through an API call, the ad server may generate the state access mechanism. At 776-1, the ad server may launch an instance of the native application. At 776-2, the ad server navigates to the advertised state of the native application. The ad server may navigate to the advertised state by selecting specific graphical user interface (GUI) elements in the native application. At 766-3, the ad server generates the state access mechanism for the advertised state by capturing an access URL of the advertised state. Alternatively, the ad server may generate the state access mechanism for the advertised state by generating a script (e.g., by recording a macro) that can redirect a client computing device from a default state of the native application to the advertised state of the native application.

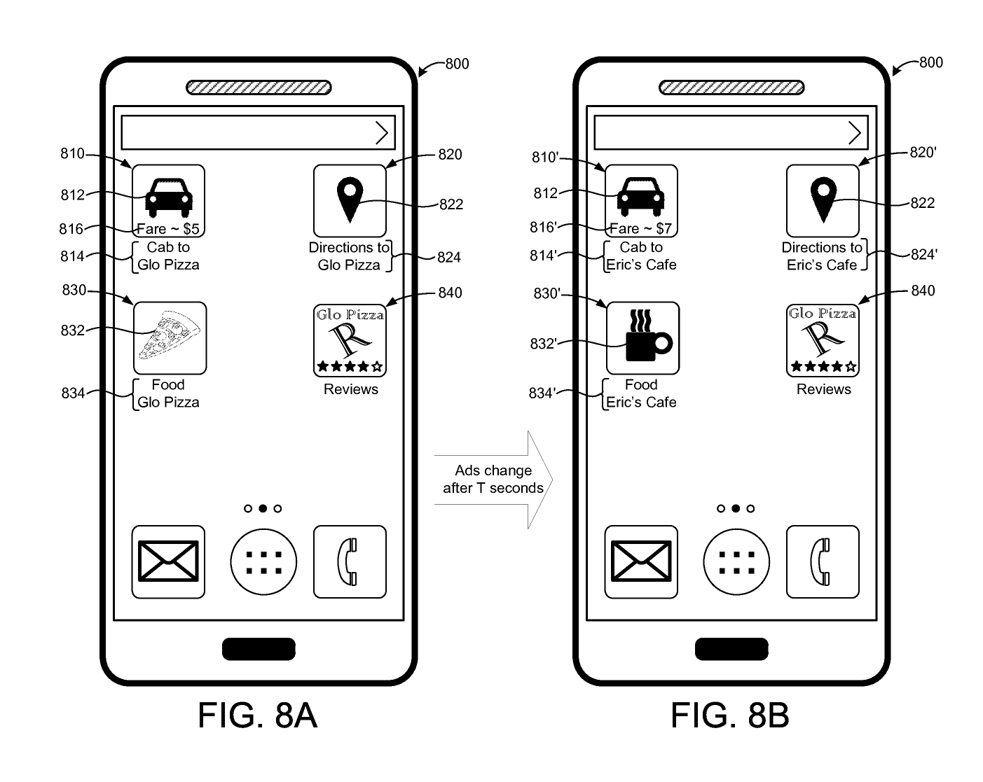

FIGS. 8A and 8B are diagrams illustrating the mobile computing device 800 displaying advertisements in the application launcher by changing the advertisements after a threshold amount of time (e.g., T seconds, for example, 5 seconds). The mobile computing device 800 (e.g., the application launcher) may determine the threshold amount of time (e.g., based on user input). Alternatively, the ad server may specify the threshold amount of time (e.g., via the ad object). The mobile computing device 800 may change the ads displayed in the application launcher by changing the icon image, the icon caption and/or the information overlaid on top of the icon image.

In the example of icons 810 and 810′, the mobile computing device 800 changes the ads by modifying the icon caption 814 to the icon caption 814′ and by replacing the overlaid information 816 with the overlaid information 816′. However, the mobile computing device 800 may not change the icon image 812. In the example of icons 820 and 820′, the mobile computing device 800 changes the ads by modifying the icon caption 824 to the icon caption 824′. However, the mobile computing device 800 does not change the icon image 822. In the example of icons 830 and 830′, the mobile computing device 800 changes the ads by replacing the icon image 832 with the icon image 832′ and by modifying the icon caption 834 to the icon caption 834′. In the example of icon 840, the mobile computing device 800 does not change the ad displayed by the icon 840.

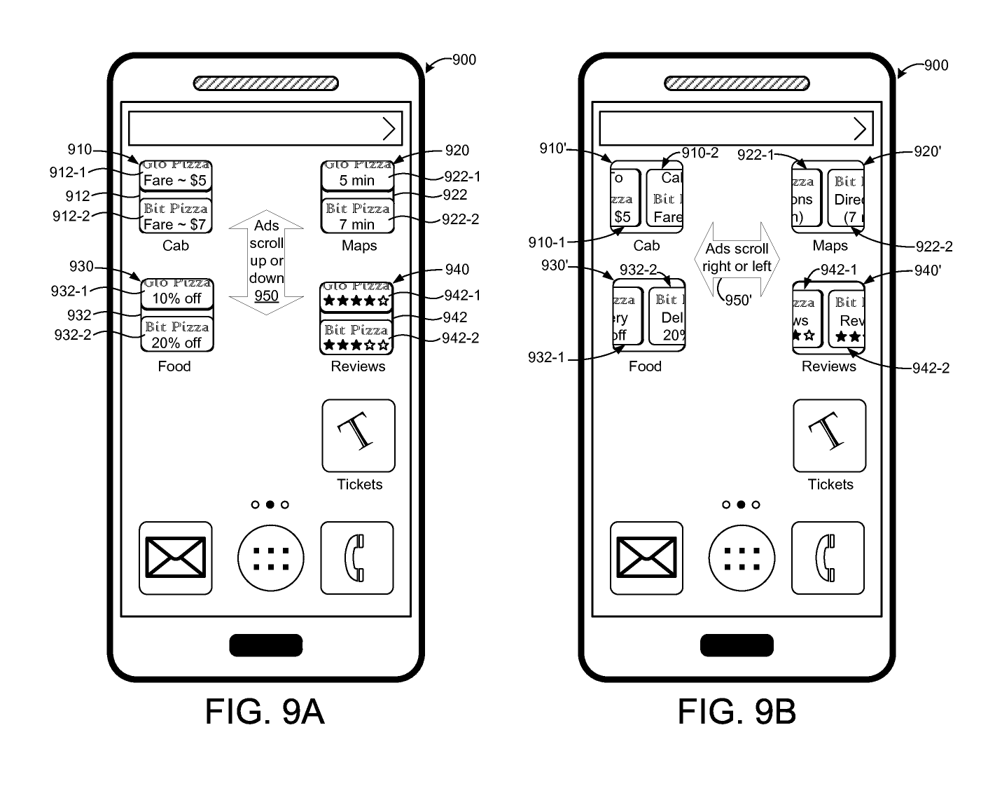

FIGS. 9A and 9B are diagrams illustrating the mobile computing device 900 displaying advertisements in the application launcher by scrolling advertisement images vertically or horizontally. Referring to FIG. 9A, the mobile computing device 900 (e.g., the application launcher) displays icons (e.g., icons 910 . . . 940). Each icon displays an icon image (e.g., icon images 912 . . . 942). The icon images display advertisements by scrolling advertisement images (e.g., ad images 912-1, 912-2 . . . 942-2) in one of the directions indicated by the arrow 950 (e.g., upwards or downwards). Referring to FIG. 9B, the mobile computing device 900 displays icons 910′ . . . 940′ that display advertisements by scrolling the ad images 912-1 . . . 942-2 in one of the directions indicated by the arrow 950′ (e.g., right-to-left or left-to-right).

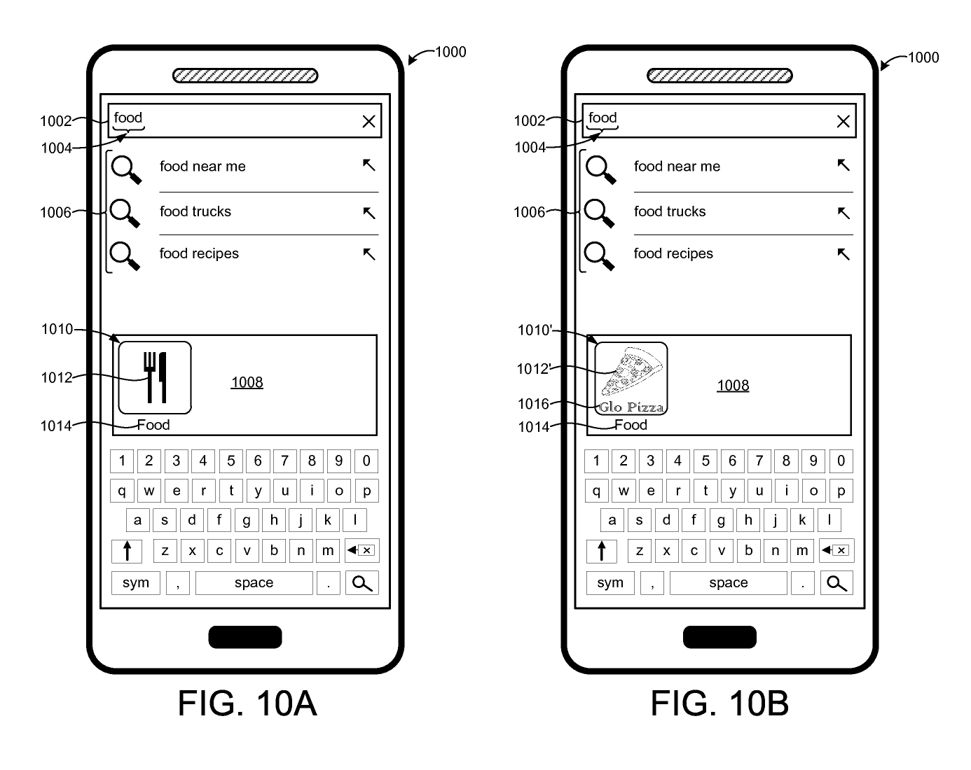

FIGS. 10A and 10B are diagrams illustrating a mobile computing device 1000 displaying advertisements in the application launcher by replacing an icon image with an advertisement image based on a search query. The mobile computing device 1000 includes an application launcher that enables a user to search for a native application by entering a search query 1004 in a search box 1002. The application launcher may use the search query 1004 to conduct a local search (e.g., on-device search) and an internet search. For the internet search, the application launcher may display suggestions 1006 based on the search query 1004. For the local search, the application launcher displays an application tray 1008 that displays one or more icons 1010 based on the search query 1004. The icon 1010 includes an icon image 1012 and an icon caption 1014. The application launcher may display the icon 1010 in the application tray 1008 in response to the icon caption 1014 matching with the search query 1004.

Referring to FIG. 10B, the mobile computing device 1000 (e.g., the application launcher) may display advertisements in the application tray 1008 through the icon 1010′. For example, the application launcher may replace the icon image 1012 with an advertisement image 1012′. Additionally, the application launcher may superimpose an advertising text 1016 onto the advertisement image 1012′. Although in the example of FIG. 10B, the icon caption 1014 remains unchanged, the application launcher may replace the icon caption 1014 with the advertising text 1016.

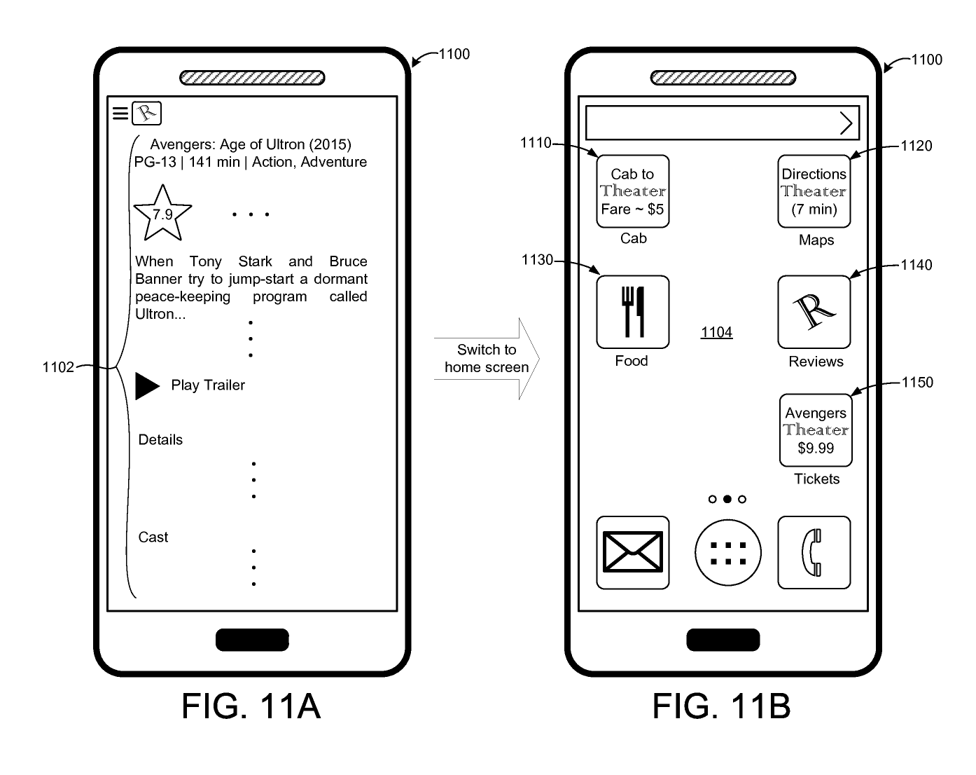

FIGS. 11A and 11B are diagrams illustrating a mobile computing device 1100 displaying advertisements in the application launcher based on a state of a native application being displayed on the mobile computing device prior to the home screen. Referring to FIG. 11A, the mobile computing device 1100 is displaying a state 1102 of a native application. In the example of FIG. 11A, the state 1102 is displaying a review of a movie called ‘Avengers: Age of Ultron’. The native application displaying the state 1102 may be a native review application that displays reviews (e.g., crowd-sourced reviews or expert-curated reviews) of various entities (e.g., movies, restaurants, businesses, etc.).

Referring to FIG. 11B, when the mobile computing device 1100 switches to displaying a home screen 1104, the mobile computing device 1100 may display ads in the application launcher. The mobile computing device 1100 displays the ads through one or more of the icons 1110 . . . 1150. The ads can be based on the state 1102 that the mobile computing device 1100 was displaying prior to displaying the home screen 1104. For example, the icon 1110 for launching the native cab application displays an ad for requesting a cab to a theater. Similarly, the icon 1120 for launching a native maps application displays an ad for getting directions to the theater. Furthermore, the icon 1150 for launching a native ticketing application displays an ad for buying tickets to watch the Avengers movie at the theater.

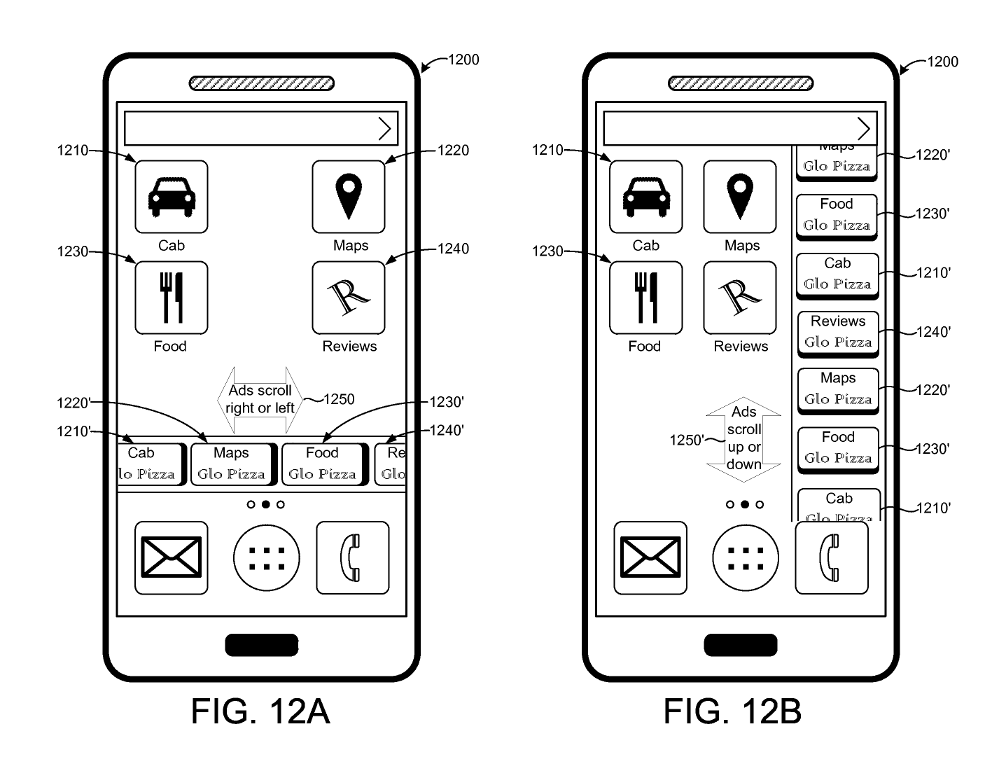

FIGS. 12A and 12B are diagrams illustrating a mobile computing device 1200 displaying advertisements in the application launcher by scrolling the advertisements horizontally or vertically. The mobile computing device displays icons 1210 . . . 1240. Upon receiving a user selection of the icons 1210 . . . 1240, the mobile computing device 1200 launches their respective native applications into the default states. The mobile computing device 1200 can display ads by displaying modified icons 1210′ . . . 1240′. Each of the modified icons 1210′ . . . 1240′ may be associated with an advertised state, within their respective native applications that may be different from the default state. Upon receiving a user selection of the modified icons 1210′ . . . 1240′, the mobile computing device 1200 launches the corresponding with native application directly into the advertised state. Referring to FIG. 12A, the mobile computing device 1200 may display the ads by scrolling the modified icons 1210′ . . . 1240′ in one of the directions indicated by the arrow 1250 (e.g., right-to-left or left-to-right). Referring to FIG. 12B, the mobile computing device 1200 may display the ads by scrolling the modified icons 1210′ . . . 1240′ in one of the directions indicated by the arrow 1250′ (e.g., upwards or downwards).

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A mobile computing device comprising:
a touchscreen display;
a memory storing a native application;
a transceiver;
sensors;
a computing processor that executes computer-readable instructions that, when executed by the computing processor, cause the computing processor to:
display an icon corresponding with the native application on the touchscreen display via an application launcher that launches the native application to a first state of the native application, the icon comprising a first image associated with the native application;
capture contextual data indicating a context of the mobile computing device, the contextual data comprising: sensor measurements from the sensors, a search history indicating searches made by the mobile computing device and/or an application identifier (ID) identifying the native application;
generate a first data container representing an advertisement request, the advertisement request comprising the contextual data;
transmit the advertisement request via the transceiver; and
in response to transmitting the advertisement request:
receive a second data container representing an advertisement object, the advertisement object comprising information related to an advertisement, the information comprising:
the application ID of the native application; and
a state ID that identifies a second state of the native application, the second state being associated with the advertisement;
determine a second image, the second image representing the second state that is being advertised;
modify the icon by replacing the first image with the second image; and
display the modified icon on the touchscreen display via the application launcher.

2. The mobile computing device of claim 1, wherein the advertisement object includes the second image; and wherein determining the second image comprises retrieving the second image from the advertisement object.

3. The mobile computing device of claim 1, wherein determining the second image comprises retrieving the second image from the memory.

4. The mobile computing device of claim 1, wherein determining the second image comprises:
launching the native application as a background operation;
navigating to the second state; and
including information displayed by the second state in the second image.

5. The mobile computing device of claim 1, wherein determining the second image comprises:
making an application programming interface (API) call to request information displayed by the second state;
receiving the requested information in response to making the API call; and
displaying the received information in the second image.

6. The mobile computing device of claim 1, wherein the computing processor is further configured to configure the application launcher to launch the native application into the second state of the native application upon receiving a user selection of the icon.

7. The mobile computing device of claim 6, wherein the computing processor is further configured to:
receive the user selection of the icon; and
launch the native application into the second state of the native application upon receiving the user selection.

8. The mobile computing device of claim 1, wherein the advertisement object further comprises information related to a second advertisement, the second advertisement indicating:
the application ID of the native application; and
a third state of the native application, the third state being associated with the second advertisement.

9. The mobile computing device of claim 8, wherein the computing processor is further configured to:
start a timer upon replacing the first image with the second image;
determine a third image that represents the third state that is being advertised; and
replace the second image with the third image upon the timer expiring.

10. The mobile computing device of claim 9, wherein the computing processor is further configured to:
configure the application launcher to launch the native application into the third state of the native application upon receiving a user selection of the icon;
receive the user selection of the icon; and
launch the native application into the third state of the native application upon receiving the user selection.

11. The mobile computing device of claim 1:
wherein the icon further comprises a first text string that represents the native application, the application launcher displaying the first text string adjacent to the first image;
wherein the computing processor is further configured to determine a second text string, the second text string representing the second state that is being advertised; and
wherein modifying the icon comprises replacing the first text string with the second text string.

12. A server comprising:
a network communication device;
a storage device that stores information related to advertisements; and
a processing device that executes computer-readable instructions that, when executed by the processing device, cause the processing device to:
receive a first data container representing an advertisement request, the advertisement request comprising contextual data that indicates a context of a client computing device, the contextual data comprising an application identifier (ID) that identifies a native application installed at the client computing device;
determine advertisements corresponding with states of the native application indicated by the application identifier;
for each determined advertisement, determine a relevance score to indicate the relevance of the advertisement based on the context of the client computing device;
select a threshold number of the advertisements based on the relevance score of the advertisements;
for each selected advertisement:
determine an icon-sized image that represents the state corresponding with the advertisement;
determine an icon-sized string that represents the state corresponding with the advertisement; and
determine a state access mechanism that an application launcher on the client computing device uses to launch the native application into the state corresponding with the advertisement;
generate a second data container representing an advertisement object, the advertisement object comprising the icon-sized images, the icon-sized strings, and the state access mechanisms of the selected advertisements; and
transmit the second data container to the client computing device via the network communication device.

13. The server of claim 12, wherein determining the advertisements comprises:
using the application ID in the advertisement request to query an inverted index that indexes application IDs to advertisement records stored in the storage device; and
receiving advertisement record identifiers that identify advertisement records corresponding with the application ID in the advertisement request, wherein the advertisement records store information related to the advertisements.

14. The server of claim 12:
wherein the contextual data indicates a location of the client computing device; and
wherein determining the relevance score of the advertisement comprises determining whether the advertisement is relevant at the location of the client computing device.

15. The server of claim 12:
wherein the contextual data indicates a time zone of the client computing device; and
wherein determining the relevance score of the advertisement comprises determining whether the advertisement is relevance at a current time in the time zone of the client computing device.

16. The server of claim 12:
wherein the contextual data indicates a search history comprising searches made by the client computing device; and
wherein determining the relevance score of the advertisement comprises determining whether the advertisement is related to an entity corresponding with search terms in the searches.

17. The server of claim 12:
wherein the contextual data indicates information displayed within a second native application installed at the client computing device during a threshold time period prior to receiving the advertisement request; and
wherein determining the relevance score of the advertisement comprises determining whether the advertisement is related to an entity corresponding with the information displayed in the second native application.

18. The server of claim 12, wherein selecting the threshold number of advertisements comprises selecting one to five advertisements with the highest relevance scores.

19. The server of claim 12, wherein determining the icon-sized image comprises making an application programming interface (API) call to request information displayed by the state of the native application that corresponds with the advertisement.

20. The server of claim 12, wherein determining the state access mechanism comprises determining a uniform resource locator (URL) that identifies the native application and the state of the native application corresponding with the advertisement.

21. A mobile computing device comprising:
a touchscreen display;
a memory storing a native application;
a transceiver;
sensors;
a computing processor that executes computer-readable instructions that, when executed by the computing processor, cause the computing processor to:
display an icon corresponding with the native application on the touchscreen display via an application launcher that launches the native application to a first state of the native application, the icon comprising a first image associated with the native application;
capture contextual data indicating a context of the mobile computing device, the contextual data comprising: sensor measurements from the sensors, a search history indicating searches made by the mobile computing device and/or an application identifier (ID) identifying the native application;
generate a first data container representing an advertisement request, the advertisement request comprising the contextual data;
transmit the advertisement request via the transceiver; and
in response to transmitting the advertisement request, receive a second data container representing an advertisement object, the advertisement object comprising information related to an advertisement, the advertisement indicating:
the application ID of the native application; and
a state ID that identifies a second state of the native application, the second state being associated with the advertisement; and
means for displaying the advertisement in the application launcher.

22. The mobile computing device of claim 21, wherein the means for displaying the advertisement comprises the computing processor executing computer-readable instructions that, when executed by the computing processor, cause the computing processor to:
determine a second image, the second image representing the second state that is being advertised;
modify the icon by replacing the first image with the second image; and
display the modified icon on the touchscreen display via the application launcher.

23. The mobile computing device of claim 22, wherein the means for displaying the advertisement further comprise the computing processor continuously modifying the icon to cycle between the first image and the second image.

24. The mobile computing device of claim 21, wherein the means for displaying the advertisement comprises the computing processor executing computer-readable instructions that, when executed by the computing processor, cause the computing processor to:
determine a text string, the text string representing the second state that is being advertised;
modify the icon by superimposing the text string onto the first image; and
display the modified icon on the touchscreen display via the application launcher.

25. The mobile computing device of claim 21, wherein the means for displaying the advertisement comprises the computing processor executing computer-readable instructions that, when executed by the computing processor, cause the computing processor to:
determine a text string, the text string representing the second state that is being advertised;
modify the icon by replacing an icon label displayed adjacent to the first image with the text string; and
display the modified icon on the touchscreen display via the application launcher.

26. The mobile computing device of claim 21, further comprising means for launching the native application in the second state that is being advertised.

27. The mobile computing device of claim 26, wherein the means for launching the native application in the second state comprises the computing processor executing computer-readable instructions that, when executed by the computing processor, cause the computing processor to:
configure the application launcher to launch the native application in the second state upon receiving a user selection of the icon;
receive the user selection of the icon; and
launch the native application in the second state of the native application.
